(19) United States
(12) Patent Application Publication
(10) Pub. No.: US 2026/0039074 A1
(43) Pub. Date: Feb. 5, 2026

(54) BUSBAR CLIP-TYPE CONNECTOR AND CLAMP TERMINAL THEREOF

(71) Applicant: JESS-LINK PRODUCTS CO., LTD., New Taipei City (TW)

(72) Inventors: Hsu-Feng CHANG, New Taipei City (TW); Zhen-Xiong SHUAI, New Taipei City (TW); Hong-Kun DENG, New Taipei City (TW)

(21) Appl. No.: 18/823,705

(22) Filed: Sep. 4, 2024

(30) Foreign Application Priority Data
Aug. 2, 2024 (CN) 202421863148.3

(51) Int. Cl. H01R 25/14

(52) U.S. Cl. CPC H01R 25/142

(57) ABSTRACT

A busbar clip-type connector includes an insulating body and two clamp terminals mounted on the insulating body. The clamp terminal includes a first elastic piece, a second elastic piece, and a connecting rib. The first elastic piece includes a first plate, first elastic arms, and first gaps. The second elastic piece includes a second plate, second elastic arms, and second gaps. The first and second elastic arms protrude from the first and second plates. Each first gap is defined between two adjacent first elastic arms. Each second gap is defined between two adjacent second elastic arms. The first and second elastic pieces are folded through the connecting rib connected between the first and second plates. The first and second plates are overlapped and adhered to each other. The first elastic arms are inserted in the second gaps, and the second elastic arms are inserted in the first gaps.

### BACKGROUND OF THE DISCLOSURE

### Technical Field

The present disclosure relates to a connector, and particularly, to a busbar clip-type connector and a clamp terminal thereof.

### Description of Related Art

Busbar clip-type connectors are mainly used in electronic devices such as servers and energy storage cabinets. The busbar chip-type connector's head end is used to clamp a conductive plate, while its tail end is connected to a plurality of cables. In terms of clamping the conductive plate, the busbar clip-type connector uses two clamp terminals that are opposite to each other to clamp, thereby transmitting power.

The clamp terminal is difficult to be integrally formed at one time because a plurality of elastic arms for clamping must be arranged close to each other side by side. Therefore, the related-art clamp terminal has been adapted into a two-piece combination. This setup includes two elastic pieces, a first independent elastic piece and a second independent elastic piece, which are independent entities. The first independent elastic piece extends a plurality of first elastic arms which are spaced apart from each other side by side, and the second independent elastic piece extends a plurality of second elastic arms which are spaced apart from each other side by side. The two independent elastic pieces which are independent entities are overlapped such that each first elastic arm is located in a gap between any two adjacent second elastic arms, and at the same time, each second elastic arm is located in a gap between any two adjacent first elastic arms. This configuration ensures all the first elastic arms and all the second elastic arms are closely aligned side by side. Since all the first elastic arms or all the second elastic arms of each independent elastic piece are spaced side by side when manufacturing the independent elastic piece, this design solves the problem of difficulty in integral formation at one time.

However, after the two independent elastic pieces are overlapped with each other, the related-art clamp terminal requires additional processes such as welding or riveting on parts other than the elastic arms of the two independent elastic pieces, so as to fix them into the desired clamp terminal. However, such welding or riveting may adversely affect the current transmission within the clamp terminal. Considering the current transmission is crucial for the clamp terminal used to clamp the conductive plate, this is a significant drawback.

Therefore, addressing the shortcomings of the aforementioned related art is a significant challenge that the inventor of this application is keenly determined to resolve.

### SUMMARY OF THE INVENTION

An objective of the present application is to provide a busbar clip-type connector and its clamp terminal which do not affect the current transmission.

In order to achieve the above objective, the present application provides a clamp terminal, for a busbar clip-type connector. The clamp terminal includes a plurality of thickness edges and further includes: a first elastic piece, including a first plate, a plurality of first elastic arms, and a plurality of first gaps, the first plate including a protruding edge and a connecting edge, the first elastic arms protruding from the protruding edge of the first plate, each of the first gaps being located between any two adjacent first elastic arms; a second elastic piece, including a second plate, a plurality of second elastic arms, and a plurality of second gaps, the second plate including a protruding edge and a connecting edge, the second elastic arms protruding from the protruding edge of the second plate, each of the second gaps being located between any two adjacent second elastic arms; and at least one connecting rib integrally connected between the connecting edge of the first plate and the connecting edge of the second plate; wherein the first elastic piece and the second elastic piece are folded towards each other, with the at least one connecting rib serving as a folding point, so that the first plate and the second plate are overlapped and adhered to each other, and each of the first elastic arms is correspondingly inserted into one of the second gaps, and each of the second elastic arms is correspondingly inserted into one of the first gaps, and the connecting edge of the first plate and the connecting edge of the second plate jointly constitute one of the thickness edges.

The present application further provides a busbar clip-type connector, which is connected to a plurality of cables. The busbar clip-type connector includes: an insulating body; and a pair of clamp terminals mentioned above, the pair of clamp terminals being disposed opposite to each other on the insulating body, wherein in each of the clamp terminals, the first plate and the second plate overlapped and adhered to each other are connected to the cables.

Compared to the related art, the present application offers the following advantages: by having a connecting rib connected between the connecting edges of the first and second elastic pieces of the clamp terminal, the overlapping and tightly contacting state between the first elastic piece and the second elastic piece may be secured by the connecting rib. This eliminates the need for additional processing or fixing between the surfaces of the first and second plates, ensuring uninterrupted current transmission.

### BRIEF DESCRIPTION OF THE DRAWINGS

FIG. 1 is a perspective view of a busbar clip-type connector connected to cables according to the present application.

FIG. 2 is a partially enlarged schematic view based on FIG. 1 of the present application.

FIG. 3 is a perspective view of a clamp terminal in an expanded state according to a first embodiment of the present application.

FIG. 4 is a perspective view of the clamp terminal according to the first embodiment of the present application.

FIG. 5 is a schematic cross-sectional view according to FIG. 4 of the present application.

FIG. 6 is a schematic perspective view of the busbar clip-type connector of the present application, showing a pair of clamp terminals.

FIG. 7 is a schematic cross-sectional view according to FIG. 6 of the present application.

FIG. 8 is a perspective view of the clamp terminal in an expanded state according to a second embodiment of the present application.

FIG. 9 is a perspective view of the clamp terminal according to the second embodiment of the present application.

### DETAILED DESCRIPTION

The detailed description and technical content of the present application are illustrated with reference to the drawings as follows. However, the attached drawings are only for reference and illustration, and are not intended to limit the present application.

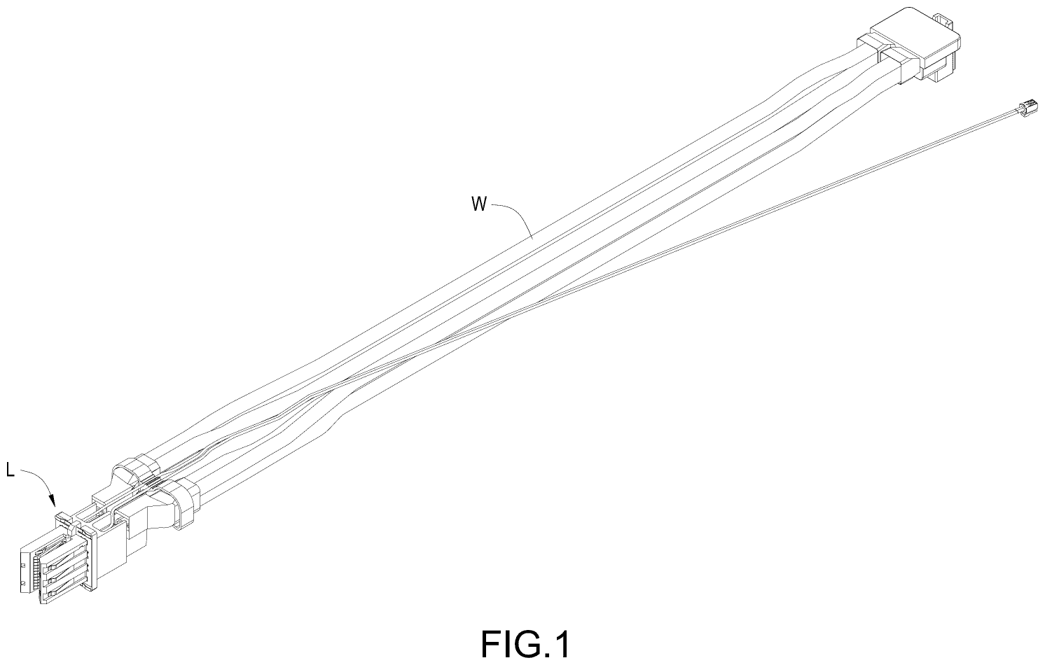

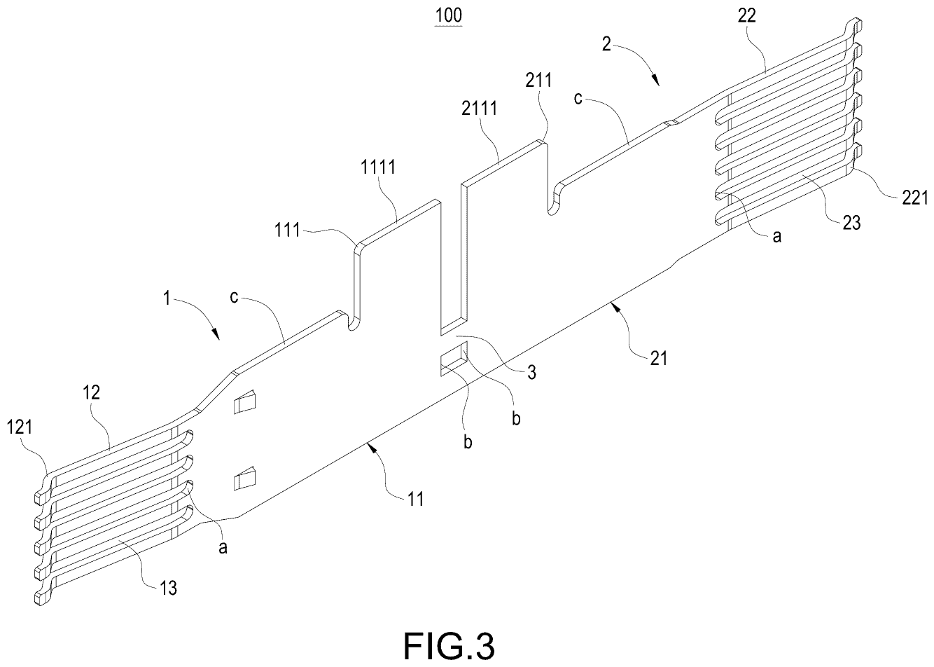

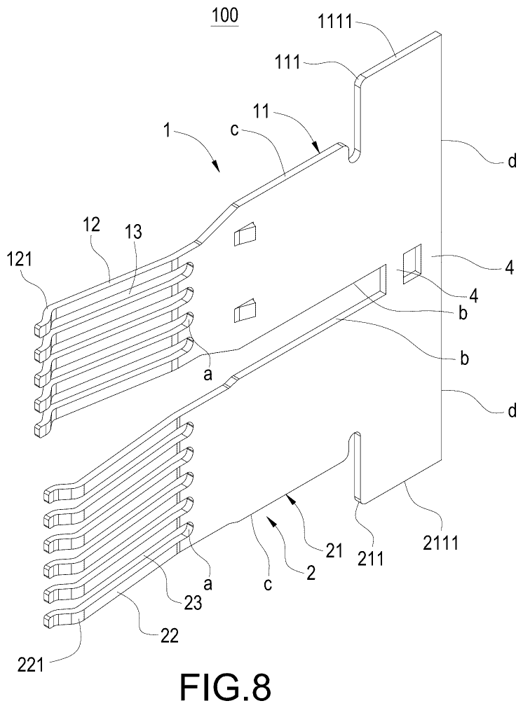

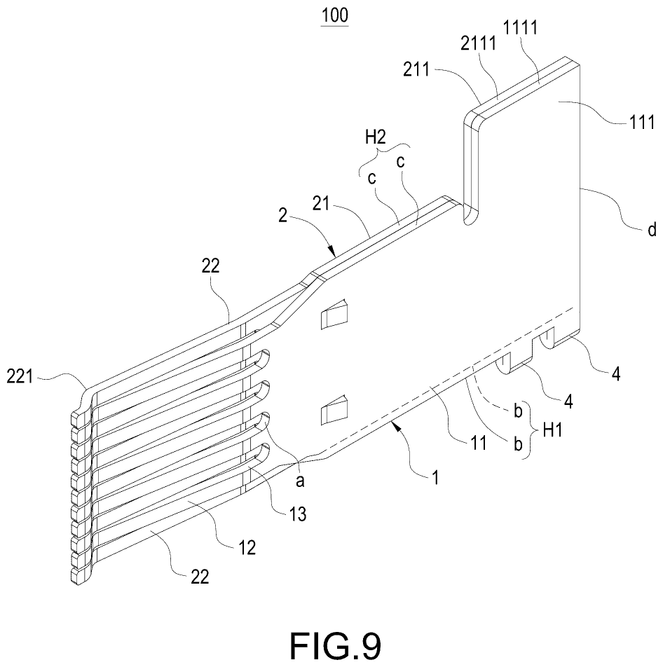

The present application provides a busbar clip-type connector and a clamp terminal thereof. As shown in FIG. 1, one end of the busbar clip-type connector L is used to clamp a conductive plate (not illustrated in figures), and the other end is connected to a plurality of cables W. In the drawings, FIGS. 3 to 5 show the first embodiment of the clamp terminal 100 in the present application, and FIGS. 8 to 9 show the second embodiment of the clamp terminal 100.

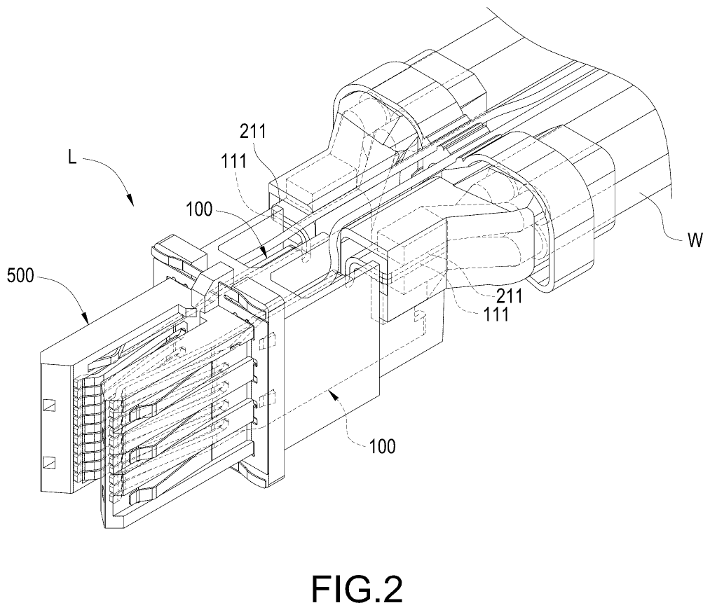

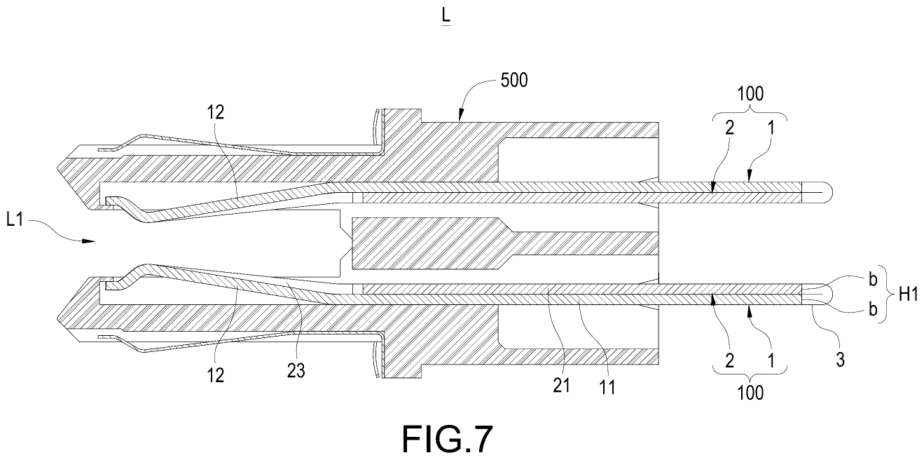

As shown in FIGS. 1 to 2 and FIGS. 6 to 7, the busbar clip-type connector L of the present application includes an insulating body 500 and a pair of clamp terminals 100. The pair of clamp terminals 100 are disposed opposite to each other on the insulating body 500, and the pair of clamp terminals 100 are spaced apart from each other to form a clamping opening L1 (see FIG. 7) at one end for clamping the aforementioned conductive plate. The other ends of the pair of the clamp terminals 100 are used to connect the aforementioned cable W (see FIG. 2).

FIG. 3 shows a semi-finished product of the clamp terminal 100 which is still in an expanded state, according to the first embodiment. The clamp terminal 100 is a conductive metal product and includes: a first elastic piece 1, a second elastic piece 2, and at least one connecting rib 3 arranged side by side, and the connecting rib 3 is connected between the first elastic piece 1 and the second elastic piece 2.

The first elastic piece 1 includes a first plate 11, a plurality of first elastic arms 12, and a plurality of first gaps 13. The first plate 11 includes a plurality of sides surrounding the first plate 11, and these sides include a protruding edge a, a connecting edge b, a fixing edge c, and the other edge (not marked with a reference symbol). In the first embodiment, the protruding edge a and the connecting edge b are opposite to each other, and the fixing edge c and the other edge are opposite to each other.

The first elastic arms 12 protrude from the protruding edge a of the first plate 11 in a spaced and side-by-side manner, so that the first gap 13 is formed between any two adjacent first elastic arms 12.

The second elastic piece 2 includes a second plate 21, a plurality of second elastic arms 22, and a plurality of second gaps 23. The second plate 21 includes a plurality of sides surrounding it, and these sides also include a protruding edge a, a connecting edge b, a fixing edge c, and the other edge (not marked with a reference symbol). In the first embodiment, the protruding edge a and the connecting edge b are also opposite to each other, and the fixing edge c and the other edge are also opposite to each other. In this way, the connecting edge b of the first plate 11 and the connecting edge b of the second plate 21 are respectively located at two opposite inner edges of the clamp terminal 100 in the expanded state, and the two protruding edges a are located at two opposite outer edges.

The second elastic arms 22 protrude from the protruding edge a of the second plate 21 in a spaced and side-by-side manner, so that the second gap 23 is formed between any two adjacent second elastic arms 22.

In other words, the shape and structure of the second elastic piece 2 are substantially the same as those of the first elastic piece 1, and the second elastic piece 2 differs from the first elastic piece 1 only in that the positions of the second elastic arms 22 are corresponding to the first gaps 13 of the first elastic piece 1, and the positions of the second gaps 23 are corresponding to the first elastic arms 12 of the first elastic piece 1.

The number of the connecting ribs 3 is not limited in the present application, and may be one or more. In this embodiment, two connecting ribs 3 are illustrated as an example. Each connecting rib 3 is integrally connected between the first elastic piece 1 and the second elastic piece 2. Specifically, it is integrally connected in a bridging manner between the connecting edge b of the first plate 11 and the connecting edge b of the second plate 21. Each of the first plate 11 and the second plate 21 has two long sides opposite to each other and two short sides opposite to each other. The protruding edge a and the connecting edge b are the two short sides, and the fixing edge c and the other edge are the two long sides. In other words, in the first embodiment, the connecting edge b of the first plate 11 and the connecting edge b of the second plate 21, connected to the connecting ribs 3, are both on the short sides as shown in FIG. 3.

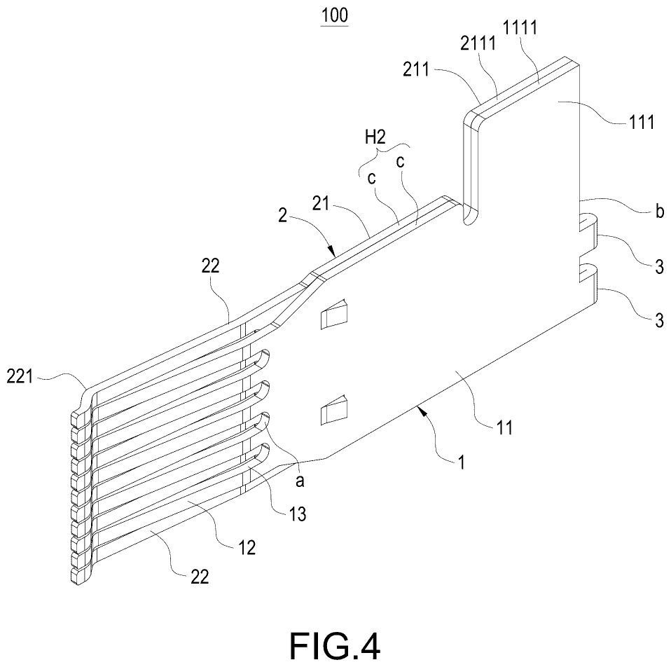

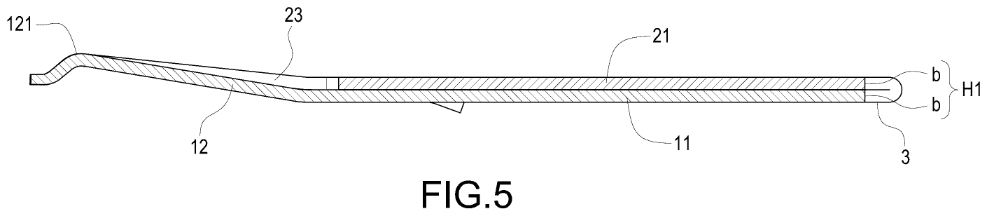

FIGS. 4 and 5 show a finished product of the clamp terminal 100 according to the first embodiment. The implementation involves folding the first elastic piece 1 and the second elastic piece 2 towards each other, causing the first plate 11 and the second plate 21 to be overlapped and adhered, forming a plurality of thickness edges. In this configuration, each first elastic arm 12 is inserted into each corresponding second gap 23, and each second elastic arm 22 is inserted into each corresponding first gap 13, with the first elastic arms 12 and the second elastic arms 22 closely aligned side by side. It should be noted that each first elastic arm 12 includes a contact portion 121, and each second elastic arm 22 includes a contact portion 221. Specifically, after folding, all the contact portions 121 and all the contact portions 221 are arranged side by side on the same straight line, ensuring that the clamp terminal 100 makes flush electrical contact with the aforementioned conductive plate. Additionally, this folding uses each connecting rib 3 as a folding point (specifically, using the aforementioned short sides for folding). Consequently, after folding, each connecting rib 3 is bent and connected between the two connecting edges b, which are overlapped to each other and together form a first thickness edge H1 (to be explained later).

In detail, after folding, the connecting edge b of the first plate 11 and the connecting edge b of the second plate 21 jointly form the aforementioned first thickness edge H1 of the clamp terminal 100 (see FIG. 5), and the fixing edge c of the first plate 11 and the fixing edge c of the second plate 21 jointly form a second thickness edge H2 of the clamp terminal 100 (see FIG. 4). The protruding edges a and the further edges of the first and second plates 11, 21 also jointly form a third thickness edge and a fourth thickness edge, both of which are not marked with reference symbols.

In this application, the clamp terminal 100 of the busbar clip-type connector L is securely held by the connecting rib 3 which is connected between the connecting edge b of the first elastic piece 1 and the connecting edge b of the second elastic piece 2. This configuration allows the first and second elastic pieces 1 and 2, once folded and closely contacted, to be securely held by the connecting rib 3 without the need for additional processing or securing between surfaces of the first plate 11 and the second plate 21. Moreover, the connecting rib 3 is affixed to the first thickness edge H1, ensuring a complete and seamless surface-to-surface contact between the first plate 11 and the second plate 21. This setup preserves the integrity of electrical current transmission and effectively doubles the current carrying capacity, making it suitable for high-current applications.

In some embodiments, additional spot welding or fusion welding may be performed on other thickness edges of the clamp terminal 100, such as the second thickness edge H2, besides the first thickness edge H1. This is to further enhance the fixing strength between the first elastic piece 1 and the second elastic piece 2. It should be noted that since the spot welding or the fusion welding is performed on the thickness edges, it does not impact the transmission of current.

In addition, as shown in FIGS. 3 and 4, the first plate 11 and the second plate 21 may also integrally extend with a first protruding piece 111 and a second protruding piece 211 respectively. Specifically, the first protruding piece 111 and the second protruding piece 211 extend from the fixing edge c of the first plate 11 and the fixing edge c of the second plate 21 respectively. The first protruding piece 111 and the second protruding piece 211 both include a plurality of surrounding edges, and these surrounding edges include the surrounding edges 1111 and 2111.

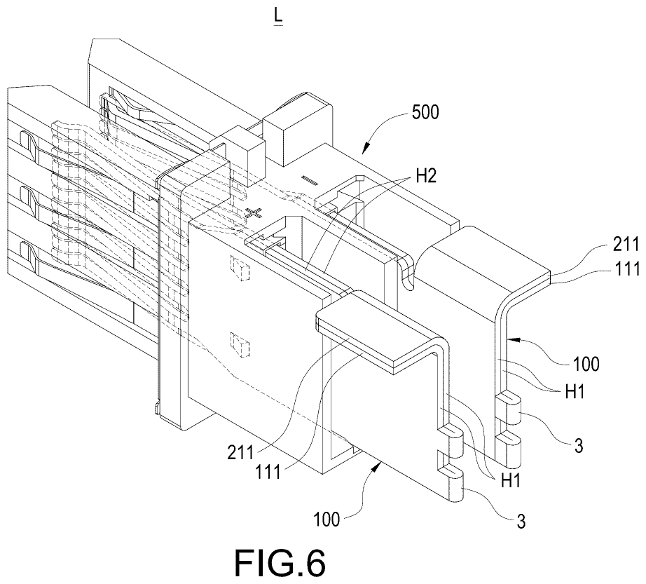

After folding, the first protruding piece 111 and the second protruding piece 211 are overlapped and adhered, facilitating the connection of the previously mentioned cable W (e.g., by welding, fusion welding, or riveting) at this place as depicted in FIG. 2. Specifically, this connection may also be formed into the tabbed ear shape shown in FIG. 6 to connect the cable W. For high current applications, each clamp terminal 100 may be connected to at least two cables W after folding, resulting in the busbar clip-type connector L being connected to a minimum of four cables W in total. Additionally, the spot welding or fusion welding previously applied to enhance fixing strength may be shifted to the surrounding edge 1111 of the first protruding piece 111 and the surrounding edge 2111 of the second protruding piece 211, where these surrounding edges 1111 and 2111 are overlapped. This not only allows the first and second protruding pieces 111 and 211 to connect the cable W but also strengthens their fixing strength through spot welding or fusion welding. Certainly, this reinforcement by spot welding or fusion welding may, for example, be concurrently applied to the second thickness edge H2 and to both the two surrounding edges 1111 and 2111.

It should also be noted that, as shown in FIGS. 3 and 4, a surrounding edge of the first protruding piece 111 (not marked with a reference symbol) forms a straight line with the connecting edge b of the first plate 11, and a surrounding edge of the second protruding piece 211 (not marked with a reference symbol) also forms a straight line with the connecting edge b of the second plate 21. In this way, the first protruding piece 111 and the second protruding piece 211 may be located at the aforementioned other end of the clamp terminal 100, which is convenient for connecting the cable W.

FIG. 8 shows a semi-finished product of the clamp terminal 100 in an expanded state according to the second embodiment. The second embodiment is generally similar to the aforementioned first embodiment, with the difference being that the connection position of the connecting rib 4 differs from that of the first embodiment. The details are described later.

The first plate 11 and the second plate 21 are also rectangular, and they both have a protruding edge a, a connecting edge b, a fixing edge c, and the other edge d surrounding each other. In the second embodiment, in each of the first and second plates 11 and 21, the protruding edge a is opposite to the additional edge d, and the connecting edge b is opposite to the fixing edge c. In this way, the connecting edge b of the first plate 11 and the connecting edge b of the second plate 21 are respectively located at two opposite inner edges of the clamp terminal 100 in the expanded state, and the two fixing edges c are located at two opposite outer edges. It should be noted that each of the first plate 11 and the second plate 21 has two long sides opposite to each other and two short sides opposite to each other. The protruding edge a and the other edge d are the two short sides, and the connecting edge b and the fixing edge c are the two long sides. In other words, in this second embodiment, the connecting edge b of the first plate 11 and the connecting edge b of the second plate 21, connected by the connecting rib 4, are both on the long sides as shown in FIG. 8.

FIG. 9 shows a finished product of the clamp terminal 100 from the second embodiment. In this embodiment, the first elastic piece 1 and the second elastic piece 2 are folded towards each other using each connecting rib 4 as a folding point (that is, folded along the previously mentioned long sides). This results in the first plate 11 and the second plate 21 overlapping and adhering closely. Consequently, each first elastic arm 12 is inserted into the corresponding second gap 23, and each second elastic arm 22 is inserted into the corresponding first gap 13, with all the first and second elastic arms 12 and 22 tightly aligned side by side.

In this way, the clamp terminal 100 in the second embodiment also has all the effects of the first embodiment.

In summary, the busbar clip-type connector and its clamp terminal presented in this application successfully meet the intended use and effectiveness, addressing the deficiencies of related art.

The descriptions provided above represent only some embodiments of this application. The scope of this patent is not limited to these descriptions alone. Any equivalent structural modifications derived from the contents of this application's specification and drawings fall within the intended scope of the patent rights, as duly noted herein.

What is claimed is:

1. A clamp terminal, for a busbar clip-type connector, the clamp terminal comprising:
a plurality of thickness edges;
a first elastic piece, comprising a first plate, a plurality of first elastic arms, and a plurality of first gaps, the first plate comprising a protruding edge and a connecting edge, the first elastic arms protruding from the protruding edge of the first plate, each of the first gaps defined between any two of the first elastic arms adjacent to each other;
a second elastic piece, comprising a second plate, a plurality of second elastic arms, and a plurality of second gaps, the second plate comprising a protruding edge and a connecting edge, the second elastic arms protruding from the protruding edge of the second plate, each of the second gaps defined between any two of the second elastic arms adjacent to each other; and
at least one connecting rib, integrally connected between the connecting edge of the first plate and the connecting edge of the second plate;
wherein the first elastic piece and the second elastic piece are overlapped and adhered to each other through the at least one connecting rib serving as a folding point, each of the first elastic arms is correspondingly inserted in one of the second gaps, each of the second elastic arms is correspondingly inserted in one of the first gaps, and one of the thickness edges is structured jointly by the connecting edge of the first plate and the connecting edge of the second plate.

2. The clamp terminal according to claim 1, wherein each of the first plate and the second plate comprises a fixing edge, another one of the thickness edges is structured jointly by the fixing edge of the first plate and the fixing edge of the second plate, and the fixing edge of the first plate and the fixing edge of the second plate are welded or fusion welded.

3. The clamp terminal according to claim 1, wherein the first plate and the second plate are both rectangular in shape, the connecting edge of the first plate is opposite to the protruding edge of the first plate, and the connecting edge of the second plate is opposite to the protruding edge of the second plate.

4. The clamp terminal according to claim 1, wherein each of the first plate and the second plate comprises two short sides opposite to each other and two long sides opposite to each other, and two connecting edges connected to the at least one connecting rib are the short sides.

5. The clamp terminal according to claim 1, wherein the first plate and the second plate are both rectangular in shape and each comprises a fixing edge, the connecting edge of the first plate is opposite to the fixing edge of the first plate, and the connecting edge of the second plate is opposite to the fixing edge of the second plate.

6. The clamp terminal according to claim 1, wherein each of the first plate and the second plate comprises two short sides opposite to each other and two long sides opposite to each other, and two connecting edges connected to the at least one connecting rib are the long sides.

7. The clamp terminal according to claim 1, wherein each of the first elastic arms comprises a contact portion, each of the second elastic arms comprises a contact portion, and the contact portion of each of the first elastic arms and the contact portion of each of the second elastic arms are arranged side by side on a same straight line.

8. The clamp terminal according to claim 1, wherein the first plate comprises a first protruding piece integrally extended therefrom, the second plate comprises a second protruding piece integrally extended therefrom, and the first protruding piece and the second protruding piece are overlapped and adhered to each other.

9. The clamp terminal according to claim 8, wherein each of the first protruding piece and the second protruding piece comprises a plurality of surrounding edges, one of the surrounding edges of the first protruding piece is overlapped with one of the surrounding edges of the second protruding piece, and two surrounding edges overlapped with each other are welded or fusion welded.

10. A busbar clip-type connector, connected to a plurality of cables, the busbar clip-type connector comprising:
an insulating body; and
a pair of clamp terminals according to claim 1, the pair of clamp terminals disposed opposite to each other on the insulating body, wherein in each of the clamp terminals, the first plate and the second plate overlapped and adhered to each other are connected to the cables.

11. The busbar clip-type connector according to claim 10, wherein in each of the clamp terminals, each of the first plate and the second plate each comprises a fixing edge, another one of the thickness edges is structured jointly by the fixing edge of the first plate and the fixing edge of the second plate, and the fixing edge of the first plate and the fixing edge of the second plate are welded or fusion welded.

12. The busbar clip-type connector according to claim 10, wherein in each of the clamp terminals, the first plate and the second plate are both rectangular in shape, the connecting edge of the first plate is opposite to the protruding edge of the first plate, and the connecting edge of the second plate is opposite to the protruding edge of the second plate.

13. The busbar clip-type connector according to claim 10, wherein in each of the clamp terminals, each of the first plate and the second plate each comprises two short sides opposite to each other and two long sides opposite to each other, and two connecting edges connected to the at least one connecting rib are the short sides.

14. The busbar clip-type connector according to claim 10, wherein in each of the clamp terminals, the first plate and the second plate are both rectangular in shape and each comprises a fixing edge, the connecting edge of the first plate is opposite to the fixing edge of the first plate, and the connecting edge of the second plate is opposite to the fixing edge of the second plate.

15. The busbar clip-type connector according to claim 10, wherein in each of the clamp terminals, each of the first plate and the second plate comprises two short sides opposite to each other and two long sides opposite to each other, and two connecting edges connected to the at least one connecting rib are the long sides.

16. The busbar clip-type connector according to claim 10, wherein in each of the clamp terminals, each of the first elastic arms and each of the second elastic arms comprises a contact portion, and the contact portion of each of the first elastic arms and the contact portion of each of the second elastic arms are arranged side by side on a same straight line.

17. The busbar clip-type connector according to claim 10, wherein in each of the clamp terminals, the first plate comprises a first protruding piece integrally extended therefrom, the second plate comprises a second protruding piece integrally extended therefrom, and the first protruding piece and the second protruding piece are overlapped and adhered to each other.

18. The busbar clip-type connector according to claim 17, wherein in each of the clamp terminals, each of the first protruding piece and the second protruding piece comprises a plurality of surrounding edges, one of the surrounding edges of the first protruding piece is overlapped with one of the surrounding edges of the second protruding piece, and two surrounding edges overlapped with each other are welded or fusion welded.
